(19) United States
(12) Patent Application Publication
(10) Pub. No.: US 2008/0269451 A1
(43) Pub. Date: Oct. 30, 2008

(54) Antimicrobial Polymers

(75) Inventors: Robert Engel, Carle Place, NY (US); JaimeLee I. Rizzo, Glen Cove, NY (US); Karin Melkonian, Garden City, NY (US); Paul Watt, West Yorkshire (GB)

Correspondence Address: PHILIP S. JOHNSON;JOHNSON & JOHNSON, ONE JOHNSON & JOHNSON PLAZA, NEW BRUNSWICK, NJ, 08933-7003, US

(73) Assignee: ETHICON, INC., Somerville, NJ (US)

(21) Appl. No.: 10/567,389

(22) PCT Filed: Aug. 12, 2004
(86) PCT No.: PCT/GB2004/003465

§ 371 Date: Jul. 11, 2008

(30) Foreign Application Priority Data
Aug. 12, 2003 (GB) 0318896.8

(51) Int. Cl. C08F 251/00

(52) U.S. Cl. 527/313; 527/314

(57) ABSTRACT

The present invention is concerned with providing antimicrobial compounds and processes for the production thereof. More particularly, the present invention provides antimicrobial polymeric materials comprising a polymer linked to a positively charged moiety via a carboxyl group. The present invention also provides processes for the production of such antimicrobial compounds and uses therefor.

### FIELD OF THE INVENTION

The present invention is concerned with providing antimicrobial compounds and processes for the production thereof. More particularly, the present invention provides antimicrobial polymeric materials.

### BACKGROUND OF THE INVENTION

In developing new antimicrobial materials, it is important to discourage further antibiotic resistance. Ideally, therefore, novel antimicrobial materials will function through non-specific, non-metabolic mechanisms.

For example, polycationic (quaternary ammonium) strings developed in the laboratory of Robert Engel are reported to have antibacterial activity. See Fabian et al, Syn. Lett., 1007 (1997); Strekas et al, Arch. Biochem. and Biophys. 364, 129-131 (1999); and Cohen et al, Heteroat. Chem. II, 546-555 (2000). No suggestion has been made, however, to attach these molecules to surfaces to render the surfaces antimicrobial. Nor have there been any reports regarding which of these molecules would be most effective when attached to surfaces.

Suggestions have been made to attach other antibiotic agents, such as gentamycin and penicillin, to the surface of medical devices. See, for example, Keogh et al. U.S. Pat. No. 5,476,509, Ung-Chhun et al, U.S. Pat. No. 6,306,454, Keogh, U.S. Pat. No. 6,033,719, Ragheb et al, U.S. Pat. No. 6,299,604, and Guire, U.S. Pat. No. 5,263,992. See also Kanazawa et al., Polym. Sci., Part A-I 37, 1467-1472 (1993).

There is, clearly, a need for new materials having antimicrobial agents stably attached to their surfaces. Ideally, the antimicrobial agents do not lead to resistance, and are not detached from their surfaces when the material is washed.

### SUMMARY OF THE INVENTION

In accordance with a first aspect of the present invention, there is provided an antimicrobial polymeric compound having formula (1):

P—(X)ₙ (1)

wherein:

P comprises a polymer linked to X via a carboxyl group;

X comprises a group —(R—V^{m+}—R¹—R²) q(Y^{p-});

n is an integer of 1-1×10⁷;

R is independently selected from divalent hydrocarbon radicals;

V comprises a positively charged moiety;

m represents an integer;

R¹ is independently selected from divalent hydrocarbon radicals;

R² is independently selected from the group consisting of —H, —SH, —F, —Cl, —Br, —I, —OR³, —HN(O)CR⁴, or —O(O)CR⁵, wherein R³, R⁴ and R⁵ are independently selected from the group consisting of —H and monovalent hydrocarbon radicals;

Y represents an anion;

q represents m/p; and,

p represents an integer;

or a pharmaceutically acceptable derivative of a compound of formula (1).

The polymer, P, preferably comprises a carboxyl group-containing polysaccharide. Preferred polysaccharides are selected from the group consisting of carboxyl group-containing celluloses, modified starches, oxidized regenerated cellulose, chitosans, guar gums, glycans, galactans, glucans, xanthan gums, alginic acids, polymannuric acids, hyaluronic acids, polyglycosuronic and polyguluronic acids, mannans, dextrins, cyclodextrins and mixtures thereof, as well as other synthetically carboxylated or naturally occurring carboxylated polysaccharides, which may be linear or branched. P may be a furanosan or pyranosan associated with proteins, lipids, or other molecules, and may include algal, plant, bacterial and mucopolysaccharides, glycogen, pectin, glycoproteins, and glycolipids.

P may comprise a synthetic polymer. Preferred synthetic polymers include those obtainable by homo- or co-polymerisation of (meth)acrylic monomers. Preferred monomers are selected from the group consisting of (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, toluoyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, (meth)acrylic acid-ethylene oxide adducts, trifluoromethylmethyl (meth)acrylate, 2-trifluoromethylethyl (meth)acrylate, 2-perfluoroethylethyl (meth)acrylate, 2-perfluoroethyl-2 perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate and mixtures thereof.

Synthetic polymers may be graft or direct polymers or copolymers.

Preferably, polymer P is not biodegradable.

Hyaluronic acid, gellan, xanthan, succinoglycan, pectin, oxidized regenerated cellulose, chondroitin sulphate, heparan sulphate, dermatan are preferred examples of carboxylated polysaccharides. Alginic acid and hyaluronic acid are most preferred, particularly alginic acid.

Preferably, the polymer P comprises 10-1×10⁷ monomeric units, more preferably 20-1×10⁶, more preferably 30-1×10⁵, more preferably 40-1×10⁴ most preferably greater than 1000 monomeric units.

Preferably, greater than 10% of the monomeric units in the polymer comprise at least one carboxyl group, more preferably, greater than 25%, more preferably greater than 50%, more preferably greater than 70%, more preferably greater than 80%, more preferably greater than 90% of the monomeric units in the polymer comprise at least one carboxyl group.

Preferably, greater than 0.1% of the carboxyl groups in the polymer are modified with group X. More preferably, greater than 1%, more preferably greater than 5%, more preferably greater than 10% of the carboxyl groups in the polymer are modified with group X.

In another preferred embodiment, the carboxylated polysaccharide comprises oxidized cellulose. Oxidized cellulose is produced by the oxidation of cellulose, for example with dinitrogen tetroxide. This process converts primary alcohol groups on the saccharide residues to carboxylic acid group, forming uronic acid residues within the cellulose chain.

The preferred oxidized cellulose oxidized regenerated cellulose (ORC) prepared by oxidation of a regenerated cellulose, such as rayon. It has been known for some time that ORC has haemostatic properties. ORC has been available as a haemostatic product called SURGICEL (Registered Trade Mark of Johnson & Johnson Medical, Inc.) since 1950. This product is produced by the oxidation of a knitted rayon material.

A modification of porosity, density and knit pattern led to the launch of a second ORC fabric product, INTERCEED (Registered Trade Mark—Johnson & Johnson Medical, Inc.) which was shown to reduce the extend of post-surgical adhesions in abdominal surgery. Preferably, the oxidised cellulose has an average molecular weight greater than 50,000. Such oxidised cellulose is substantially insoluble in wound fluids, but will undergo very gradual breakdown into bioresorbable fragments at physiological pH. Preferably, the oxidized cellulose is not neutralized.

R is preferably selected from the group consisting of C₁₋₂₀ alkanediyl, C₂₋₂₀ alkenediyl, C₂₋₂₀ alkynediyl, C₃₋₃₀ cycloalkanediyl, C₃₋₃₀ cycloalkenediyl, C₅₋₃₀ cycloalkynediyl, C₇₋₃₀ aralkylenediyl, C₇₋₃₀ alkarylenediyl and C₅₋₃₀ arylenediyl.

R is more preferably selected from the group consisting of C₁₋₁₆ alkanediyl, C₂₋₁₆ alkenediyl, C₂₋₁₆ alkynediyl, C₄₋₂₀ cycloalkanediyl, C₄₋₂₀ cycloalkenediyl, C₅₋₂₀ cycloalkynediyl, C₇₋₂₀ aralkylenediyl, C₇₋₂₀ alkarylenediyl and C₆₋₂₀ arylenediyl.

R is more preferably selected from the group consisting of straight chain C₁₋₁₆ alkanediyl, C₂₋₁₆ alkenediyl, C₆₋₁₆ aralkylenediyl and C₆₋₁₆ alkarylenediyl.

Most preferably, R is selected from methylene, 1,2-ethylene, 1,2-propylene, 1,3-propylene, 1,2-butylene, 1,3-butylene, 1,4-butylene, 1,5-pentylene, 1,6-hexylene, 1,8-octylene, 1,10-decylene and 1,12-dodecylene.

All groups R may be the same.

R may contain no heteroatoms.

R may comprise hydrocarbon chains that all contain the same number of carbon atoms.

Preferably, R comprises a mixture of hydrocarbon chains.

Preferably, R has greater than 2 carbon atoms in the chain, preferably 3 to 10, and more preferably 3, 6, 8 or 10.

R¹ is preferably selected from the group consisting of C₁₋₃₀ alkanediyl, C₂₋₃₀ alkenediyl, C₂₋₃₀ alkynediyl, C₃₋₃₅ cycloalkanediyl, C₃₋₃₅ cycloalkenediyl, C₅₋₃₅ cycloalkynediyl, C₇₋₃₅ aralkylenediyl, C₇₋₃₅ alkarylenediyl and C₅₋₃₅ arylenediyl.

R¹ is more preferably selected from the group consisting of C₁₋₁₈ alkanediyl, C₂₋₁₈ alkenediyl, C₂₋₁₈ alkynediyl, C₄₋₂₀ cycloalkanediyl, C₄₋₂₀ cycloalkenediyl, C₅₋₂₀ cycloalkynediyl, C₇₋₂₀ aralkylenediyl, C₇₋₂₀ alkarylenediyl and C₆₋₂₀ arylenediyl.

R¹ is more preferably selected from the group consisting of straight chain C₁₋₁₈ alkanediyl, C₂₋₁₈ alkenediyl, C₆₋₁₈ aralkylenediyl and C₆₋₁₈ alkarylenediyl.

All groups R¹ may be the same.

Preferably, R¹ may comprise a mixture of hydrocarbon chains. Preferably, at least some of the hydrocarbon chains R¹ in the mixture have 12-18 carbon atoms, preferably 12-16 carbon atoms, more preferably 12 or 16 carbon atoms. In particular, for each compound (1), group X comprising a mixture of R¹ carbon chain lengths of C₁₂ to C₁₆ inclusive, are preferred.

R² is preferably —H.

Y preferably represents an anion, or plurality of anions, which may be the same or different, that balance the charge of positively charged moiety V. The anion may be singly charged, in which case p in formula (1) is 1, doubly charged, in which case p in formula (1) is 2, and so on.

Examples of suitable anions, Y, include, N-hydroxysuccinimidyl, N-hydroxybenzotriazolyl, nitrate, sulfate, bisulfate, phosphate (mono-, bi-, or triphosphate), carbonate, bicarbonate, acetate, tosylates, mesylates, brosylates, and halides including chloride, bromide, and iodide, and mixtures thereof.

Preferably, m is an integer of 1, 2, 3, 4, 5 or 6. Preferably, p is an integer of 1, 2, 3, 4, 5 or 6. Preferably, m is 1, 2 or 3, preferably 1 or 2. Preferably p is 1, 2 or 3, preferably 1 or 2.

Preferably, the overall charge of the compound of formula (1) is neutral, therefore, for example, when m=2 and p=1, q=2. Alternatively, for example, when m=2 and p=2, q=1. Alternatively, for example, when m=1 and p=1, q=1. Alternatively for example, when m=1 and p=2, q=½. Alternatively for example, when m=3 and p=2, q=3/2. Alternatively for example, when m=2 and p=3, q=⅔.

A mixture of anions may be employed, having a mixture of charges. Thus, for any particular tri-cationic moiety V (m=3), Y may be, for example, C₁ and CO₃²⁻. Thus, the overall negative charge contributed by the anions, Y, for that V moiety is −3. In this case, q is 2, and p is 1 and 2 for Cl— and CO₃²⁻ respectively.

Where there is more than one anion, Y, in a compound of formula (1) and/or where q=2 or more, Y may be the same or different, preferably the same.

R³, R⁴ and R⁵ are preferably independently selected from the group consisting of —H, C₁₋₂₀ alkyl, C₂₋₂₀ alkenyl, C₂₋₂₀ alkynyl, C₃₋₃₀ cycloalkyl, C₃₋₃₀ cycloalkenyl, C₄₋₃₀ cycloalkynyl, C₇₋₃₀ aralkyl, C₇₋₃₀ alkaryl and C₅₋₃₀ aryl.

R³, R⁴ and R⁵ are more preferably independently selected from the group consisting of —H, C₁₋₁₅ alkyl, C₂₋₁₅ alkenyl, C₂₋₁₅ alkynyl, C₃₋₂₀ cycloalkyl, C₃₋₂₀ cycloalkenyl, C₄₋₂₀ cycloalkynyl, C₇₋₂₀ aralkyl, C₇₋₂₀ alkaryl and C₁₋₂₀ aryl.

R³, R⁴ and R⁵ are more preferably independently selected from the group consisting of —H, straight chain C₁₋₁₀ alkyl, C₂₋₁₀ alkenyl and C₆₋₁₂ aryl.

Most preferably, R³, R⁴ and R⁵ are independently selected from the group consisting of —H, methyl, ethyl, propyl, butyl, hexyl, cyclohexyl, octyl, nonyl, dodecyl, eicosyl, norbornyl and adamantyl, vinyl, propenyl, cyclohexenyl, benzyl, phenylethyl, phenylpropyl, phenyl, tolyl, dimethylphenyl, trimethylphenyl, ethylphenyl, propylphenyl, biphenyl, naphthyl, methylnaphthyl, anthryl, phenanthryl, benzylphenyl, pyrenyl, acenaphthyl, phenalenyl, aceanthrylenyl, tetrahydronaphthyl, indanyl, biphenyl, particularly methyl, ethyl, propyl and isopropyl.

In formula (1), P preferably comprises a polysaccharide, comprising a carboxyl group that has been modified by covalent attachment of the X moiety to the polysaccharide through the carboxyl group.

Preferably, the polysaccharide, P, comprises 10-1×10⁵ monosaccharide moieties, more preferably 20-1×10⁴, more preferably 30-1×10⁴, more preferably 40-1×10⁴ most preferably greater than 100 monosaccharide moieties.

The compound of formula (1) may comprise a mixture of carboxylated monosaccharide or oligosaccharide moieties within the polysaccharide. The compound of formula (1) may comprise non-carboxylated monosaccharide or oligosaccharide moieties within the polysaccharide.

Preferably, greater than 10% of the monosaccharide moieties in the polysaccharide comprise at least one carboxyl group, more preferably, greater than 25%, more preferably greater than 50%, more preferably greater than 70%, more preferably greater than 80%, more preferably greater than 90% of the monosaccharide moieties in the polysaccharide comprise at least one carboxyl group.

Preferably, the compound of formula (1) comprises 10-1000000 carboxyl groups, preferably 20-100000, more preferably 25-10000 carboxyl groups.

Preferably, greater than 0.1% of the carboxyl groups in the polysaccharide are modified with group X. More preferably, greater than 1%, more preferably greater than 5%, more preferably greater than 10% of the carboxyl groups in the polymer are modified with group X.

V in formula (1) comprises a positively charged moiety. The positively charged moiety may, for example, be a singly or a doubly charged moiety. In some compounds, V may comprise 3, 4, 5 or 6 positive charges. In a singly charged moiety, m in formula (1) represents 1. In a doubly charged moiety, m represents 2. The singly or doubly charged moiety may, for example, comprise one or two positively charged nitrogen atoms, one or two positively charged phosphorous atoms, one or two positively charged sulfur atoms, or mixtures thereof, preferably nitrogen atoms.

In one embodiment, the positively charged moiety comprises a singly charged quaternary ammonium, quaternary phosphonium or sulfonium group, having the formula ⁺—NR⁶₂—, ⁺—PR⁷₂—, or ⁺—SR⁸—, respectively, wherein R¹, R⁷ and R⁸ are independently selected from the group consisting of H and monovalent hydrocarbon radicals.

R⁶, R⁷ and R⁸ are preferably independently selected from the group consisting of —H, C₁₋₂₀ alkyl, C₂₋₂₀ alkenyl, C₂₋₂₀ alkynyl, C₃₋₃₀ cycloalkyl, C₃₋₃₀ cycloalkenyl, C₄₋₃₀ cycloalkynyl, C₇₋₃₀ aralkyl, C₇₋₃₀ alkaryl and C₅₋₃₀ aryl.

R⁶, R⁷ and R⁸ are more preferably independently selected from the group consisting of —H, C₁₋₁₅ alkyl, C₂₋₁₅ alkenyl, C₂₋₁₅ alkynyl, C₃₋₂₀ cycloalkyl, C₃₋₂₀ cycloalkenyl, C₄₋₂₀ cycloalkynyl, C₇₋₂₀ aralkyl, C₇₋₂₀ alkaryl and C₆₋₂₀ aryl.

R⁶, R⁷ and R⁸ are more preferably independently selected from the group consisting of —H, straight chain C₁₋₁₀ alkyl, C₂₋₁₀ alkenyl and C₆₋₁₂ aryl.

Most preferably, R⁶, R⁷ and R⁸ are independently selected from the group consisting of methyl, ethyl, propyl, butyl, hexyl, cyclohexyl, octyl, nonyl, dodecyl, eicosyl, norbornyl and adamantyl, vinyl, propenyl, cyclohexenyl, benzyl, phenylethyl, phenylpropyl, phenyl, tolyl, dimethylphenyl, trimethylphenyl, ethylphenyl, propylphenyl, biphenyl, naphthyl, methylnaphthyl, anthryl, phenanthryl, benzylphenyl, pyrenyl, acenaphthyl, phenalenyl, aceanthrylenyl, tetrahydronaphthyl, indanyl, biphenyl, particularly methyl, ethyl, propyl and isopropyl.

In the quaternary ammonium ions, the two R⁶ groups on the N atom may be the same, or different. Preferably, both R⁶ groups represent methyl or ethyl.

In the quaternary phosphonium ions, the two R⁷ groups on the P atom may be the same, or different. Preferably, both R⁷ groups represent methyl or ethyl.

In a preferred embodiment, positively charged moiety V comprises two positively charged nitrogen atoms, such as, for example, —⁺NR⁶₂—R⁹—NR⁶₂⁺— or a group (A):

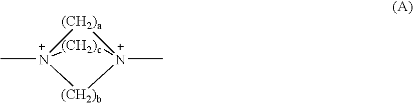

wherein a, b and c independently represent 1-10, preferably, 1-5, more preferably 1-3, most preferably 2. Preferably, a=b=c. In a particularly preferred embodiment, (A) is 1,4-diazoniabicyclo[2.2.2]octane.

In another embodiment, V comprises two positively charged sulfur atoms, such as, for example, —⁺SR⁸—R¹⁰—SR⁸⁺ or a group (B)

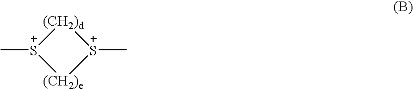

wherein d and e independently represent 1-10, preferably, 1-5, more preferably 1-3, most preferably 2. Preferably, a=b=c. In a particularly preferred embodiment, (B) is 1,4-dithioniumcyclohexane.

In another embodiment, V comprises two positively charged phosphorus atoms, such as, for example, —⁺PR⁷₂—R^{9′}—PR⁷₂⁺—, or a group (C).

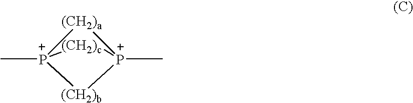

wherein a, b and c independently represent 1-10, preferably, 1-5, more preferably 1-3, most preferably 2. Preferably, a=b=c. In a particularly preferred embodiment, (C) is 1,4-diphosphoniabicyclo[2.2.2]octane.

In these embodiments, R⁶, R⁷ and R⁸ are as defined above, and R⁹, R^{9′} and R¹⁰ are preferably independently selected from the group consisting of C₁₋₂₀ alkanediyl, C₂₋₂₀ alkenediyl, C₂₋₂₀ alkynediyl, C₃₋₃₀ cycloalkanediyl, C₃₋₃₀ cycloalkenediyl, C₅₋₃₀ cycloalkynediyl, C₇₋₃₀ aralkylenediyl, C₇₋₃₀ alkarylenediyl and C₅₋₃₀ arylenediyl.

R⁹, R^{9′} and R¹⁰ are more preferably independently selected from the group consisting of C₁₋₁₆ alkanediyl, C₂₋₁₆ alklenediyl, C₂₋₁₆ alkynediyl, C₄₋₂₀ cycloalkanediyl, C₄₋₂₀ cycloalkenediyl, C₅₋₂₀ cycloalkynediyl, C₇₋₂₀ aralkylenediyl, C₇₋₂₀ alkarylenediyl and C₆₋₂₀ arylenediyl.

R⁹, R^{9′} and R¹⁰ are more preferably independently selected from the group consisting of straight chain C₁₋₁₆ alkanediyl, C₂₋₁₆ alkenediyl, C₆₋₁₆ aralkylenediyl and C₆₋₁₆ alkarylenediyl.

Most preferably, R⁹, R^{9′} and R¹⁰ are independently selected from methylene, 1,2-ethylene, 1,2-propylene, 1,3-propylene, 1,2-butylene, 1,3-butylene, 1,4-butylene, 1,5-pentylene, 1,6-hexylene, 1,8-octylene, 1,10-decylene and 1,12-dodecylene.

When V comprises —⁺PR⁷₂—R^{9′}—PR⁷₂⁺—, each R⁷ is preferably phenyl and R^{9′} is preferably ethyl, propyl or butyl.

In a particularly preferred embodiment, the compound of formula (1) comprises P—(R—V^{m+}—R¹—R²) wherein P, R, V, m, R¹ and R² are as defined above. Preferably, P—(R—V^{m+}—R¹—R²) comprises the structure:

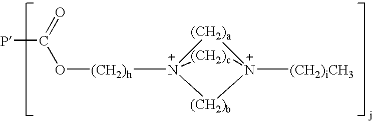

wherein P′ comprises a polysaccharide;

h represents 1-10;

a, b, and c are as defined above;

i represents 7-17; and,

j represents 10-1×10⁷.

More preferably, P—(R—V^{m+}—R¹—R²) has the structure:

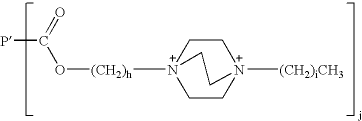

wherein P′ comprises a polysaccharide;

h represents 3-10;

i represents 11, 13 or 15; and,

j represents 30-1×10⁷.

P′ is preferably an alginate, preferably alginic acid.

j preferably represents 10-1×10⁶, more preferably 20-1×10⁵, more preferably 30-1×10⁴.

In a further aspect of the present invention there is provided a process for the preparation of a compound having formula (1), comprising reacting a compound having the formula (2):

P—{[COO⁻]f(Z^{g+})}ₙ (2)

wherein:

P is as defined above, with reference to compound (I);

n is as defined above, with reference to compound (I);

Z is a cation;

f represents 1/g; and

g represents 1, 2, 3, 4, 5 or 6;

with a group having the formula (3)

L-X (3)

wherein X is as defined above, with reference to compound (I); and,

L is a leaving group.

The term “leaving group” generally refers to groups readily displaceable by a nucleophile. Such leaving groups are well known in the art. Examples of such leaving groups include, but are not limited to, N-hydroxysuccinimide, N-hydroxybenzotriazole, nitrate, sulfate, bisulfate, phosphate (mono-, bi-, or triphosphate), carbonate, bicarbonate, acetate, tosylates, mesylates, brosylates, and halides including chloride, bromide, and iodide. Preferably, L is tosylate.

Z may be any cationic group. Z may be an inorganic or organic compound or ion. Preferably, Z is selected from Group I (g=1) and Group II (g=2) metal ions, in particular Li⁺, Na⁺, K⁺, Mg²⁺ and Ca²⁺, preferably Na⁺.

g preferably represents an integer that balances the charge of negatively charged moiety [COO⁻]. The cation may be singly charged, in which case g in formula (2) is 1; or doubly charged, in which case g in formula (2) is 2. Preferably g is 1, 2 or 3, more preferably 1 or 2.

f preferably represents a fraction or integer that balances the charge of negatively charged moiety [COO⁻]. The cation, Z, may be singly charged, in which case f in formula (2) is 1; or doubly charged, in which case f in formula (2) is ½. Preferably f 1 and g=1.

For polymers that have a carboxylic acid group, activation of carboxylic acid group preferably takes place prior to reaction with (3). Activation may be accomplished by converting the carboxylic acid group to an active carboxylate anion.

Carboxylic acid groups may be converted to an active carboxylate anion by reacting the carboxylic acid with a reagent in a suitable medium. The reagent may, for example, include a basic compound. Organic or inorganic basic compounds may be used. For example, the Group I and Group II metal hydroxides, carbonates and bicarbonates are preferred, in particular CaCO₃, NaCO₃, NaHCO₃, NaOH and KOH. Bicarbonates and hydroxides are particularly preferred. NaHCO₃ is most preferred. The activation is preferably carried out in aqueous media.

Suitable media for the activation reaction include water, hydrocarbons, ethers, halogenated hydrocarbons, ketones, alcohols, nitrites, amines, esters, carbonates and mixtures thereof. Particularly preferred solvents include water and/or alcohol(s). The amount of reagent and volume of suitable medium are known to those in the art.

It is not necessary to activate all of the available carboxylic acid sites present on the surface of a compound having formula (2). For example, less than about 10% of the available carboxylic acid groups on a surface may be activated to subsequently provide sufficient antimicrobial activity. Preferably, about 25% of the available carboxylic acid groups may be activated, more preferably about 50%, and most preferably about 75% of the available carboxylic acid groups may be activated.

The reaction of (2) with (3) preferably takes place in the presence of a solvent, preferably an organic solvent.

Preferred organic solvents include hydrocarbons, ethers, halogenated hydrocarbons, ketones, alcohols, nitrites, amines, esters, carbonates and mixtures thereof. Particularly preferred solvents are acetonitrile and alcohols.

Alternatively, or in addition to the organic solvent described above, the reaction of (2) with (3) may take place in the presence of water.

The reaction of (2) with (3) is preferably carried out at about ambient temperature (25° C.).

According to a further aspect of the present invention there is provided a pharmaceutical composition comprising a compound of the present invention in combination with a pharmaceutically acceptable excipient.

According to a further aspect of the present invention there is provided a method of preparing a pharmaceutical composition comprising the step of combining a compound of the present invention with a pharmaceutically acceptable excipient.

The compounds of the present invention are preferably used in the manufacture of antimicrobial materials. The compounds of formula (1) are suitable for manufacturing objects, such as clothing, bandages, sutures, protective gear, containers, and the like.

In a further embodiment of the present invention, there is provided a medical device comprising an antimicrobial polymeric compound having formula (1) according to the present invention. By “medical device” is meant any device designed to be used while in or on either or both human tissue or fluid. Examples of such devices include, without limitation, stents, implants, catheters, and ophthalmic lenses. In a preferred embodiment, the medical device is an ophthalmic lens including, without limitation, contact or intraocular lenses. More preferably, the device is a contact lens.

In a further embodiment of the present invention, there is provided a method for manufacturing antimicrobial medical devices comprising incorporating an effective amount of a polymeric compound having formula (1) according to the present invention into a medical device.

In a further embodiment of the present invention, there is provided a method for manufacturing medical devices comprising contacting at least one surface of a medical device with a coating effective amount of a polymeric compound having formula (1) according to the present invention.

In relation to medical devices, “antimicrobial” is preferably meant that bacterial adherence to the device surface is reduced in comparison to the uncoated surface, by about 5% or more, preferably 10% or more, preferably 30% or more.

“Contact Lens” refers to a structure that can be placed on or within a wearer's eye. A contact lens can correct, improve, or alter a user's eyesight, but that need not be the case. Structures, such as lenses, of the present invention preferably comprise at least one antimicrobial polymeric compound having formula (1) according to the present invention. When the structure of the present invention is a lens, such as a contact lens, additional polymers may be incorporated into the structure of the lens. In a preferred embodiment, a conventional contact lens is coated with a composition comprising the antimicrobial polymeric compound having formula (1) according to the present invention, or a derivative or activated analogue thereof.

Examples of preferred carboxyl functional hydrophilic polymers for use in contact lenses include, without limitation, poly(acrylic acid), poly(methacrylic acid), poly(maleic acid), poly(itaconic acid), block or random copolymers of (meth)acrylic acid, acrylic acid, maleic acid, itaconic acid with any reactive vinyl monomer, and the like, and mixtures thereof. Preferably, the carboxyl functional hydrophilic polymer is poly(acrylic acid) or poly(methacrylic acid).

Preferable additional contact lens components to the antimicrobial polymeric compound having formula (1), for incorporation into the contact lens compositions, include any of the conventional monomers, polymers, oligomers or mixtures thereof which are known in the art for the production of plastic contact lenses. These monomers, oligomers, polymers or mixtures thereof may be formulated with the antimicrobial polymeric compound having formula (1) by any method. For example, antimicrobial polymeric compound having formula (1), derivatives or activated analogues thereof, may be blended with, grafted onto by, or used to graft onto a contact lens polymer. Alternatively, antimicrobial polymeric compound having formula (1), derivatives or activated analogues thereof, may be copolymerised, terpolymerised, crosslinked, mixed etc., with any suitable contact lens material, particularly the monomeric components referred to below. Examples of additional contact lens components include, but are not limited to polymers selected from acrylics, silicones, polycarbonates and others known in the art. For example, in the area of soft contact lenses, the hydroxyethylmethacrylate and ethylene glycol dimethacrylate monomer mixtures described in U.S. Pat. No. 2,976,576 and Re. 27,401 may be used, as well as the hydroxyalkyl methacrylates and vinyl pyrrolidone described in U.S. Pat. No. 3,503,393. Specific suitable monomer materials include 2-hydroxyethyl methacrylate, 2-hydroxypropyl acrylate, glycerol methacrylate, methylmethacrylate, ethylmethacrylate, glycidyl methacrylate, dimethylaminoethyl methacrylate, acrylic acid, methacrylic acid, collagen, acrylamide, diacetone acrylamide, and the like. Included also are monomeric materials resulting in polymers such as tefilcon, phemfilcon, hefilcon A, hefilcon B, perfilcon A, lidofilcon B, tetrafilcon A, droxifilcon A, ocufilcon B, Bufilcon A, crofilcon A, deltafilcon A, netrafilcon A, and etafilcon A. These are United States approved drug names (USAN).

A particularly preferred polymer for use in contact lenses is 2-hydroxyethyl methacrylate-co-methacrylic acid.

Generally, polymers used to make contact lenses result in “hard lenses,” “soft lenses” or “hybrid lenses” as those terms are known in the art.

The contact lens structure resulting for the methods of the present invention can be finished using secondary operations known in the art as they are needed, such as, for example, cutting, grinding, edging, polishing or the like to form a lens of desired optical, cosmetic or functional quality or characteristics. For soft contact lenses, the dry lenses may be hydrated using conventional methods to form a finished product. The finished lenses can be packaged in any appropriate packaging as they are known in the art, such as vials, tubes, blisters or other structures. The packaging can include appropriate solutions and instructions for use or description of the product and its care.

The present invention further provides improved wound dressing materials for mammalian wounds, and especially for human, chronic wounds, such as venous ulcers, dicubitis ulcers and diabetic ulcers. Such chronic wounds generally exhibit little or no bleeding or adhesion to other body tissues.

Compositions and materials manufactured from a compound according to the present invention may also comprise one or more structural proteins selected from the group consisting of fibronectin, fibrin, laminin, elastin, collagen and mixtures thereof. Preferably the protein comprises collagen, and more preferably it consists essentially of collagen.

Compositions and materials manufactured from a compound according to the present invention may also comprise 0-10% by weight, preferably 0-5% by weight of one or more therapeutic wound healing agents, such as non-steroidal anti-inflammatory drugs (e.g. acetaminophen), steroids, antibiotics (e.g. penicillins or streptomycins), antiseptics (e.g. silver sulfadiazine or chlorhexidine), or growth factors (e.g. fibroblast growth factor or platelet derived growth factor). All of the above percentages are on a dry weight basis.

A wound dressing is preferably in sheet form and comprises an active layer of the compound according to the invention. The active layer would normally be the wound contacting layer in use, but in some embodiments it could be separated from the wound by a liquid-permeable top sheet. Preferably, the area of the active layer is from about 1 cm² to about 400 cm², more preferably from about 4 cm² to about 100 cm².

Preferably, the wound dressing further comprises a backing sheet extending over the active layer opposite to the wound facing side of the active layer. Preferably, the backing sheet is larger than the active layer such that a marginal region of width 1 mm to 50 mm, preferably 5 mm to 20 mm extends around the active layer to form a so-called island dressing. In such cases, the backing sheet is preferably coated with a pressure sensitive medical grade adhesive in at least its marginal region.

Preferably, the backing sheet is substantially liquid-impermeable. The backing sheet is preferably semipermeable. That is to say, the backing sheet is preferably permeable to water vapour, but not permeable to liquid water or wound exudate. Preferably, the backing sheet is also microorganism-impermeable. Suitable continuous conformable backing sheets will preferably have a moisture vapor transmission rate (MVTR) of the backing sheet alone of 300 to 5000 g/m²/24 hrs, preferably 500 to 2000 g/m²/24 hrs at 37.5° C. at 100% to 10% relative humidity difference. The backing sheet thickness is preferably in the range of 10 to 1000 micrometers, more preferably 100 to 500 micrometers.

The MVTR of the dressing according to the present invention as a whole is lower than that of the backing sheet alone, because the apertured sheet partially obstructs moisture transfer through the dressing. Preferably, the MVTR of the dressing (measured across the island portion of the dressing) is from 20% to 80% of the MVTR of the backing sheet alone, more preferably from 20% to 60% thereof, and most preferably about 40% thereof. It has been found that such moisture vapor transmission rates allow the wound under the dressing to heal under moist conditions without causing the skin surrounding the wound to macerate.

Suitable polymers for forming the backing sheet include polyurethanes and poly alkoxyalkyl acrylates and methacrylates such as those disclosed in GB-A-1280631. An endotoxin and/or exotoxin absorbent material, for example, a charcoal containing material is preferred. Preferably, the backing sheet comprises a continuous layer of a high density blocked polyurethane foam that is predominantly closed-cell. A suitable backing sheet material is the polyurethane film available under the Registered Trade Mark ESTANE 5714F.

The adhesive (where present) layer should be moisture vapor transmitting and/or patterned to allow passage of water vapor therethrough. The adhesive layer is preferably a continuous moisture vapor transmitting, pressure-sensitive adhesive layer of the type conventionally used for island-type wound dressings, for example, a pressure sensitive adhesive based on acrylate ester copolymers, polyvinyl ethyl ether and polyurethane as described for example in GB-A-1280631. The basis weight of the adhesive layer is preferably 20 to 250 g/m², and more preferably 50 to 150 g/m². Polyurethane-based pressure sensitive adhesives are preferred.

Further layers of a multilayer absorbent article may be built up between the active layer and the protective sheet.

The dressing may further comprise an absorbent layer between the active layer and the protective sheet, especially if the dressing is for use on exuding wounds. The optional absorbent layer may be any of the layers conventionally used for absorbing wound fluids, serum or blood in the wound healing art, including gauzes, nonwoven fabrics, superabsorbents, hydrogels and mixtures thereof. Preferably, the absorbent layer comprises a layer of absorbent foam, such as an open celled hydrophilic polyurethane foam prepared in accordance with EP-A-0541391, the entire content of which is expressly incorporated herein by reference. In other embodiments, the absorbent layer may be a nonwoven fibrous web, for example a carded web of viscose staple fibers. The basis weight of the absorbent layer may be in the range of 50-500 g/m², such as 160-400 g/m². The uncompressed thickness of the absorbent layer may be in the range of from 0.5 mm to 10 mm, such as 1 mm to 4 mm. The free (uncompressed) liquid absorbency measured for physiological saline may be in the range of 5 to 30 g/g at 25° C.

The wound facing surface of the dressing is preferably protected by a removable cover sheet. The cover sheet is normally formed from flexible thermoplastic material. Suitable materials include polyesters and polyolefins. Preferably, the adhesive-facing surface of the cover sheet is a release surface. For example, the cover sheet may be formed from a non-adherent plastic such as a fluoropolymer, or it may be provided with a release coating such as a silicone or fluoropolymer release coating.

Preferably, the wound dressing is sterile and packaged in a microorganism-impermeable container.

The dressings according to the present invention may further comprise other medically acceptable materials, including textile fibers such as nylon or polyester staple fibers, nontextile fibers such as meltblown nylon fibers, and bioresorbable fibers such as polylactide/polyglycolide fibers.

In another aspect, the present invention provides a method of treatment of a chronic wound in a mammal, such as a dicubitis ulcer, a venous ulcer or a diabetic ulcer. The method comprises applying a dressing as defined above to the wound.

Preferably, the dressing is applied to the chronic wound for a period of at least 1 hour, more preferably at least 6 hours, and most preferably at least 12 hours. The treatment may be extended for several days or weeks, with dressing changes as appropriate, if necessary for chronic wounds.

The compounds of the present invention may be used in a method of medical treatment, of the human or animal body, by way of therapy.

The compounds of the present invention may be used in a method of preparing a medicament, used in the treatment of bacterial infection.

The present invention further provides a method of treating a patient for bacterial infection, comprising administering a therapeutically effective amount of a compound according to the present invention.

As used herein, the term “divalent hydrocarbon radicals” refers to any straight chain, branched, cyclic, acyclic, heterocylic, saturated or unsaturated diradical, which contains a carbon backbone comprising one or more hydrogen atoms, optionally substituted with one or more heteroatoms in or on the carbon backbone. The term “divalent hydrocarbon radical” is intended to encompass the terms “alkanediyl”, “alkenediyl”, “alkynediyl”, “cycloalkanediyl”, “cycloalkenediyl”, “cycloalkynediyl”, “arylenediyl”, “aralkylenediyl” and “alkaryienediyl” as defined below.

The term “alkanediyl” refers to a straight or branched saturated divalent hydrocarbon radical having the number of carbon atoms indicated, optionally substituted with one or more heteroatoms in or on the carbon backbone.

The terms “alkenediyl” and “alkynediyl” refer to straight or branched, unsaturated divalent hydrocarbon radicals, optionally substituted with one or more heteroatoms in or on the carbon backbone. An “alkenediyl” is characterized by a carbon-carbon double bond and an “alkynediyl” is characterized by a carbon-carbon triple bond.

The term “cycloalkanediyl” refers to a cyclic saturated divalent hydrocarbon radical having the number of carbon atoms indicated, optionally substituted with one or more heteroatoms in or on the carbon backbone.

The terms “cycloalkenediyl” and “cycloalkynediyl” refer to cyclic unsaturated divalent hydrocarbon radicals, optionally substituted with one or more heteroatoms in or on the carbon backbone. A “cycloalkenediyl” is characterized by a carbon-carbon double bond and a “cycloalkynediyl” is characterized by a carbon-carbon triple bond.

The term “arylenediyl” refers to a divalent unsaturated aromatic carbocyclic radical having one or two rings, optionally substituted with one or more heteroatoms in or on the carbon backbone.

The term “alkarylenediyl” refers to a divalent unsaturated mono- or di-alkyl-substituted aromatic carbocyclic radical having one or two rings, optionally substituted with one or more heteroatoms in or on the carbon backbone. Binding is through the arylene group.

The term “aralkylenediyl” refers to a divalent unsaturated mono- or di-alkyl-substituted aromatic carbocyclic radical having one or two rings, optionally substituted with one or more heteroatoms in or on the carbon backbone. Binding is through the alkylene group.

As used herein, the term “monovalent hydrocarbon radicals” refers to any straight chain, branched, cyclic, acyclic, heterocylic, saturated or unsaturated radical, which contains a carbon backbone comprising one or more hydrogen atoms, optionally substituted with one or more heteroatoms in or on the carbon backbone. The term “monovalent hydrocarbon radical” is intended to encompass the terms “alkyl”, “alkenyl”, “alkynyl”, “cycloalkyl”, “cycloalkenyl”, “cycloalkynyl”, “alkaryl”, “aralkyl” and “aryl” as defined below.

As used herein, the term “alkyl” refers to a straight or branched saturated monovalent hydrocarbon radical, having the number of carbon atoms as indicated, optionally substituted with one or more heteroatoms in or on the carbon backbone.

As used herein, the term “alkenyl” refers to a straight or branched unsaturated monovalent hydrocarbon radical, having the number of carbon atoms as indicated, optionally substituted with one or more heteroatoms in or on the carbon backbone, and the distinguishing feature of a carbon-carbon double bond.

As used herein, the term “alkynyl” refers to a straight or branched unsaturated monovalent hydrocarbon radical, having the number of carbon atoms as indicated, optionally substituted with one or more heteroatoms in or on the carbon backbone, and the distinguishing feature of a carbon-carbon triple bond.

As used herein, the term “cycloalkyl” refers to a cyclic saturated monovalent hydrocarbon radical; having the number of carbon atoms as indicated, optionally substituted with one or more heteroatoms in or on the carbon backbone.

As used herein, the terms “cycloalkenyl” and “cycloalkynyl” refer to cyclic unsaturated monovalent hydrocarbon radicals, optionally substituted with one or more heteroatoms in or on the carbon backbone. A “cycloalkenyl” is characterized by a carbon-carbon double bond and a “cycloalkynyl” is characterized by a carbon-carbon triple bond.

As used herein, the term “aryl” refers to a monovalent unsaturated aromatic carbocyclic radical having one or two rings, optionally substituted with one or more heteroatoms in or on the carbon backbone, such as phenyl, naphthyl, indanyl or biphenyl, or to a monovalent unsaturated aromatic heterocyclic radical, optionally substituted with one or more heteroatoms in or on the carbon backbone, such as quinolyl, dihydroisoxazolyl, furanyl, imidazolyl, pyridyl, phthalimido, thienyl, thiophenyl, pyrrolyl and the like. Exemplary heterocyclic radicals include pyrrolyl, imidazolyl, pyrazolyl, thiazolyl, isothiazolyl, oxazolyl, pyrrolidinyl, pyrrolinyl, imidazolidinyl, imidazolinyl, pyrazolidinyl, tetrahydrofuranyl, pyranyl, pyronyl, pyridyl, pyrazinyl, pyridazinyl, piperidyl, piperazinyl, morpholinyl, thionaphthyl, benzofuranyl, isobenzofuryl, indolyl, oxindolyl, isoindolyl, indazolyl, indolinyl, 7-azaindolyl, isoindazolyl, benzopyranyl, coumarinyl, isocumarinyl, quinolyl, isoquinolyl, napthyridinyl, cinnolinyl, quinazolinyl, pyridopyridyl, benzoxazinyl, quinoxalinyl, chromenyl, chromanyl, isochromanyl and carbolinyl.

As used herein, the term “alkaryl” refers to an aryl group with an alkyl substituent. Binding is through the aryl group. Such groups have the number of carbon atoms as indicated, and may be substituted with one or more heteroatoms in or on the carbon backbone.

As used herein, the term “aralkyl” refers to an alkyl group with an aryl substituent, where binding is through the alkyl group. Such groups have the number of carbon atoms as indicated, and may be substituted with one or more heteroatoms in or on the carbon backbone.

As used herein, the term “substituted” is contemplated to include all permissible substituents of organic compounds. In a broad aspect, the permissible substituents include acyclic and cyclic, branched and unbranched, carbocyclic and heterocyclic, aromatic and nonaromatic substituents of organic compounds. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

As used herein, the term “heteroatom” includes N, O, S, P, Si and halogen (including F, Cl, Br and I).

By “a pharmaceutically acceptable derivative” is meant any pharmaceutically acceptable salt, ester or salt of such ester or any other compound which, upon administration to a recipient, is capable of providing (directly or indirectly) a compound (I).

Pharmaceutically acceptable salts are generally acid addition salts, which are preferably such of therapeutically acceptable inorganic or organic acids, such as strong mineral acids, for example hydrohalic. Preferred salts include hydrochloric acid, hydrobromic acid, sulfuric acid, phosphoric acid, nitric acid, aliphatic or aromatic carboxylic or sulfonic acids, for example, formic acid, acetic acid, propionic acid, succinic acid, glycolic acid, lactic acid, malic acid, tartaric acid, gluconic acid, citric acid, maleic acid, fumaric acid, pyruvic acid, phenylacetic acid, benzoic acid, 4-aminobenzoic acid, anthranilic acid, 4-hydroxybenzoic acid, salicylic acid, 4-aminosalicylic acid, pamoic acid, nicotinic acid, methanesulfonic acid, ethanesulfonic acid, hydroxyethanesulfonic acid, benzenesulfonic acid, p-toluenesulfonic acid, naphthalenesulfonic acid, sulfanilic acid, cyclohexylsulfamic acid and ascorbic acid. For compounds having a free carboxy group, pharmaceutically acceptable salts are also derived from bases, for example, alkali metal salts, such as the sodium salt, or salts derived from pharmaceutically acceptable amines.

The invention will now be described with reference to the following Examples. It will be appreciated that what follows is by way of example only and that modifications to detail may be made whilst still falling within the scope of the invention.

Activation of Carboxyl Groups:

A preferred reaction sequence is shown below. The reaction sequence begins with the deprotonation of an alginate dressing with an aqueous solution of sodium bicarbonate as illustrated in Scheme 1. Separately, the species to be conjugated with the dressing is prepared. This process involves treatment of 1,4-diazabicyclo[2.2.2]octane with one equivalent of a haloalkane in EtOAc as shown in Scheme 2. Following the isolation of the monoammonium “string,” the free amine is quaternized by the reaction of a halo-1-alkanol in CH₃CN as illustrated in Scheme 3. The final step in preparing the unsymmetrical string for conjugation to the sodium alginate dressing involves tosylation of the terminal hydroxyl group as shown in Scheme 4. The conjugation step involves treatment of the sodium alginate dressing with 2 equivalents of the unsymmetrical tosylated string in CH₃CN. Scheme 5 outlines the final reaction in this process.

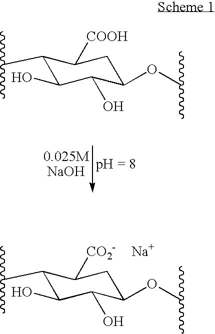

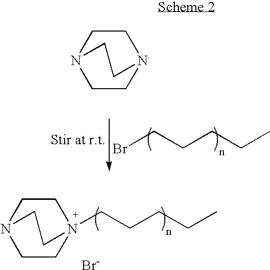

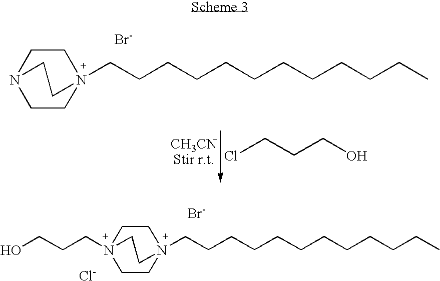

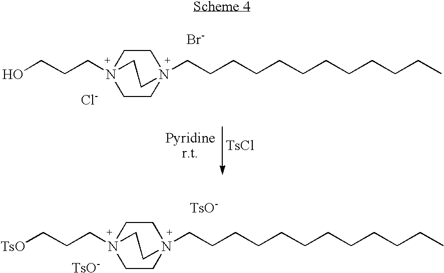

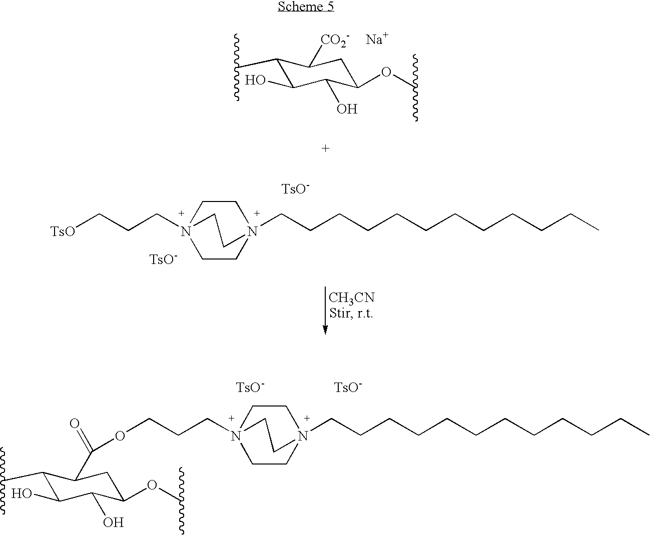

### EXPERIMENTAL

Alginate Conjugation:

An alginate dressing (Nu-Derm™) was treated with aqueous sodium bicarbonate solution to generate the carboxylic acid site in the anionic state. The concentration of the solution should be kept at 0.025 M. At higher concentrations (i.e. 0.05, 0.75, 0.1, 0.5, 1 M) the dressing is dissolved in it. The dressing is stirred in the solution for 4 days.

The separately prepared agents are constructed in a two step process. The first step involves reaction of dabco (1,4-diazabicyclo[2.2.2]octane) with the appropriate 1-haloalkane in ethyl acetate medium. The yields of these monocationic species are in the range of 85-95% and quickly precipitate out of solution. The haloalkanes used to render the derivatized alginate surfaces antimicrobial are 1-bromohexadecane and 1-bromododecane. A series of other haloalkanes including 1-bromotetradecane, 1-chlorodecane, 1-bromooctane, 1-chlorohexane, etc. have been synthesised to test their antimicrobial activity.

Subsequently, the second step involves addition of the linker for attaching the agent to the alginate surface. For this two equivalents of the halo-1-alkanol are used to insure the quaternization of the free amine. Depending on the monoammonium string used, the second quaternization may or may not need to be heated. Halo-1-alkanols used include 3-chloro-1-propanol, 4-chloro-1-butanol, 6-chloro-1-hexanol, 8-chloro-1-octanol, and 10-chloro-1-decanol. Alternatively, water and/or alcohol(s) may be used as an alternative to the acetonitrile solvent. The yield is between 40-70% depending on the monoammonium string and the haloalkanols used.

Final preparation of the agent for attachment is accomplished by tosylation of the free hydroxyl group. An excess of tosyl chloride is dissolved in aqueous sodium bicarbonate and the agent added. The reaction mixture is stirred at room temperature for two hours. Depending on the type of unsymmetrical diatonic string prepared, purification may be accomplished by washings with EtOAc and water. Some strings require washing with other solvents; others do not precipitate out of solution. Those that do not precipitate out are evaporated under reduced pressure, followed by washings for purification.

The suitably activated agent is then coupled with the alginate dressing. The string is first dissolved in the acetonitrile. Depending on the string used, heat may be required to dissolve the compound. After all is completely dissolved, the dressing is added to the solution at room temperature and the reaction mixture is stirred at room temperature for 4 days. The dressing is washed with large amounts of water followed by a wash of anhydrous ether to assist in the drying of the surface. The surface is then left to dry under the hood for one day.

The following alginate derivatives have been prepared:

alginate-C3-dab-C16

alginate-C3-dab-C12

alginate-C6-dab-C12

alginate-C6-dab-C 16

alginate-C8-dab-C16

alginate-C10-dab-C16

Antimicrobial Activity:

The materials prepared above have been subjected to surface modification according to the invention demonstrate excellent antimicrobial properties. In this specification, antimicrobial properties refer to the ability to resist growth of single cell organisms, e.g. bacteria, fungi, algae, and yeast, as well as mold.

The bacteria include both gram positive and gram negative bacteria. Some examples of Gram positive bacteria include, for example. Bacillus cereus. Micrococcus luteus, and Staphylococus aureus. Some examples of Gram negative bacteria include, for example, Escherichia coli, Enterobacter aerogenes, Enterobacter cloacae, Proteus vulgaris and Pseudomonas aeringosa. Strains of yeast include, for example, Saccharomyces cerevisiae, Candida and Aspergillus.

In order to demonstrate the antimicrobial properties achieved in accordance with the invention, the materials were modified and tested for antimicrobial activity (Table 1).

While the inventors do not wish to be bound by any theory, the antibacterial activity may be understood as occurring in a stepwise manner. The lipophilic chains may be subsumed by the bacterial species to a stage where the cationic portion is brought into intimate contact with the cell surface, and is subsumed sufficiently far that it is not easily expelled. Detergent-like action then results in cell surface disruption initiating cell destruction. A particular advantage of such action is the lack of consumption of the antibacterial agent. The antibacterial agent is not changed in the process and remains attached to the surface. Moreover, the antibacterial activity is non-specific and non-metabolic. Therefore, the danger of encouraging resistant strains of bacteria is reduced.

Summary of Results:

TABLE 1

| | | | P. | | |
|---|---|---|---|---|---|
| Alginates | E. Coli | P. vulgaris | aeruginosa | B. cereus | S. aureus |
| JE121 | 3.7 | 3.9 | 40 | 12.9 | 6.8 |
| JE132 | 0 | 0 | 33 | 0 | 0 |
| JE91 | 6.1 | 6.3 | 8 | 14.6 | 4.8 |
| TA257 | 0 | 1.1 | 0 | 0 | 0 |
| TA258 | 0.4 | 0 | 0.4 | 0 | 0 |
| TA259 | 6.7 | 0 | 0 | 0 | 0 |
| RC29 | 0 | | 0 | | 0 |

The values in each of the columns 2-6 of Table 1 indicate the percentage of growth of bacteria relative to blank systems (non-derivatised alginate).

The structures of the derivatised alginates referred to in Table 1 are as follows:

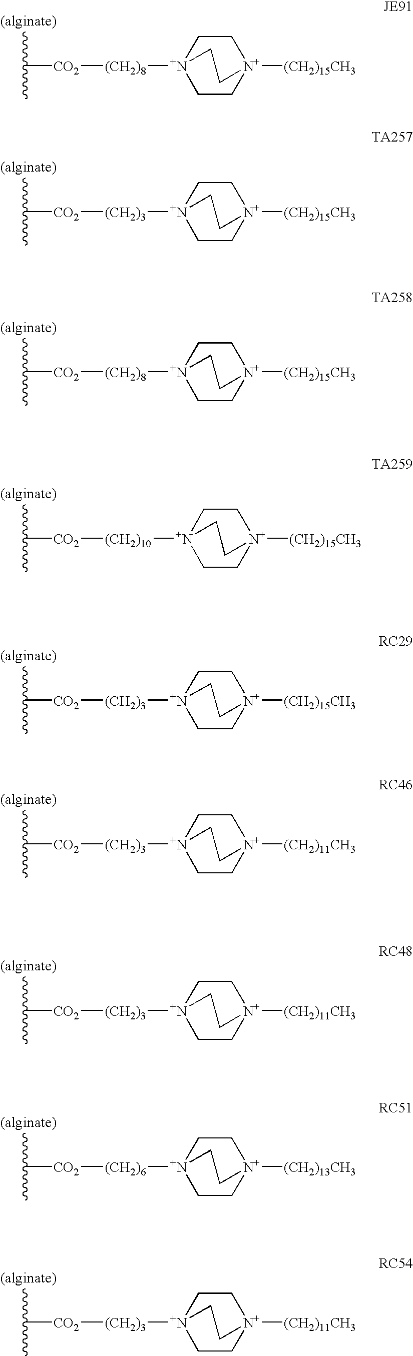

It should be understood that in the Examples illustrated above, the alginate comprises a plurality of the —(R—V^{m+}—R¹—R²) groups.

Excellent results were obtained with TA257, TA258 and TA259. This differed from the other samples in that the conjugated samples were incubated in bicarbonate for 4 days.

1. An antimicrobial polymeric compound having formula (1):
P—(X)ₙ (1)
P comprises a polymer linked to X via a carboxyl group;
X comprises a group —(R—V^{m+}—R¹—R²) q(Y^{p-});
n is an integer of 1-1×10⁷;
R is independently selected from divalent hydrocarbon radicals;
V comprises a positively charged moiety;
m represents an integer;
R¹ is independently selected from divalent hydrocarbon radicals;
R² is independently selected from the group consisting of —H, —SH, —F, —Cl, —Br, —I, —OR³, —HN(O)CR⁴, or —O(O)CR⁵, wherein R³, R⁴ and R⁵ are independently selected from the group consisting of —H and monovalent hydrocarbon radicals;
Y represents an anion;
q represents m/p; and,
p represents an integer;
or a pharmaceutically acceptable derivative of a compound of formula (1).

2. A compound according to claim 1, wherein P is a carboxyl group-containing polysaccharide.

3. A compound according to claim 2, wherein the polysaccharide is selected from the group consisting of carboxyl group-containing celluloses, modified starches, chitosans, guar gums, glycans, galactans, glucans, xanthan gums, alginic acids, polymannuric acids, hyaluronic acids, polyglycosuronic and polyguluronic acids, mannans, dextrins, cyclodextrins and mixtures thereof, as well as other synthetically carboxylated or naturally occurring carboxylated polysaccharides, which may be linear or branched, preferably hyaluronic acid, gellan, xanthan, succinoglycan, pectin, chondroitin sulphate, heparan sulphate, dermatan, more preferably alginic acid and hyaluronic acid, particularly alginic acid.

4. A compound according to claim 1, wherein the polymer comprises a synthetic polymer obtainable by homo- or co-polymerisation of a monomer selected from the group consisting of (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, toluoyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, (meth)acrylic acid-ethylene oxide adducts, trifluoromethylmethyl (meth)acrylate, 2-trifluoromethylethyl (meth)acrylate, 2-perfluoroethylethyl (meth)acrylate, 2-perfluoroethyl-2 perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate and mixtures thereof.

5. A compound according to claim 1, wherein the polymer P comprises 10-1×10⁷ monomeric units, more preferably 20-1×10⁶, more preferably 30-1×10⁵, more preferably 40-1×10⁴ most preferably greater than 1000 monomeric units.

6. A The compound according to claim 1, wherein R² is —H.

7. A The compound according to claim 6, wherein R is selected from the group consisting of C₁₋₂₀ alkanediyl, C₂₋₂₀ alkenediyl, C₂₋₂₀ alkynediyl, C₃₋₃₀ cycloalkanediyl, C₃₋₃₀ cycloalkenediyl, C₅₋₃₀ cycloalkynediyl, C₇₋₃₀ aralkylenediyl, C₇₋₃₀ alkarylenediyl and C₅₋₃₀ arylenediyl, preferably selected from the group consisting of C₁₋₁₆ alkanediyl, C₂₋₁₆ alkenediyl, C₂₋₁₆ alkynediyl, C₄₋₂₀ cycloalkanediyl, C₄₋₂₀ cycloalkenediyl, C₅₋₂₀ cycloalkynediyl, C₇₋₂₀ aralkylenediyl, C₇₋₂₀ alkarylenediyl and C₆₋₂₀ arylenediyl, more preferably selected from the group consisting of straight chain C₁₋₁₆ alkanediyl, C₂₋₁₆ alkenediyl C₆₋₁₆ aralkylenediyl and C₆₋₁₆ alkarylenediyl, most preferably, R is selected from methylene, 1,2-ethylene, 1,2-propylene, 1,3-propylene, 1,2-butylene, 1,3-butylene, 1,4-butylene, 1,5-pentylene, 1,6-hexylene, 1,8-octylene, 1,10-decylene and 1,12-dodecylene.

8. A The compound according to claim 7, wherein substantially all groups R are the same.

9. A The compound according to claim 7, wherein R represents a mixture of hydrocarbon chains.

10. A The compound according to claim 7, wherein R¹ is selected from the group consisting of C₁₋₃₀ alkanediyl, C₂₋₃₀ alkenediyl, C₂₋₃₀ alkynediyl, C₃₋₃₅ cycloalkanediyl, C₃₋₃₅ cycloalkenediyl, C₅₋₃₅ cycloalkynediyl, C₇₋₃₅ aralkylenediyl, C₇₋₃₅ alkarylenediyl and C₅₋₃₅ arylenediyl, preferably selected from the group consisting of C₁₋₁₈ alkanediyl, C₂₋₁₈ alkenediyl, C₂₋₁₈ alkynediyl, C₄₋₂₀ cycloalkanediyl, C₄₋₂₀ cycloalkenediyl, C₅₋₂₀ cycloalkynediyl, C₇₋₂₀ aralkylenediyl, C₇₋₂₀ alkarylenediyl and C₆₋₂₀ arylenediyl, more preferably selected from the group consisting of straight chain C₁₋₁₅ alkanediyl, C₂₋₁₅ alkenediyl, C₆₋₁₅ aralkylenediyl and C₆₋₁₅ alkarylenediyl, most preferably, R¹ is selected from 1,6-hexylene, 1,8-octylene, 1,10-decylene and 1,12-dodecylene.

11. The compound according to claim 10, wherein R¹ comprises a mixture of hydrocarbon chains.

12. A compound according to claim 11, wherein at least some of the hydrocarbon chains R¹ in the mixture have 12-18 carbon atoms.

13. A compound according to claim 11, wherein R¹ has greater than 10 carbon atoms in the chain.

14. The compound according to claim 10, preferably 1, 2 or 3.

15. A compound according to claim 14, wherein m 1 or 2.

16. The compound according to claim 14, wherein p is 1, 2, 3, 4, 5 or 6.

17. The compound according to claim 16, wherein Y represents one or more anions that balance the charge of positively charged moiety V.

18. The compound according to claim 17, wherein Y is selected from the group consisting of N-hydroxysuccinimidyl, N-hydroxybenzotriazolyl, nitrate, sulfate, bisulfate, phosphate (mono-, bi-, or triphosphate), carbonate, bicarbonate, acetate, tosylates, mesylates, brosylates, and halides including chloride, bromide, and iodide and mixtures thereof.

19. The compound according to claim 18, wherein R³, R⁴ and R⁵ are independently selected from the group consisting of —H, C₁₋₂₀ alkyl, C₂₋₂₀ alkenyl, C₂₋₂₀ alkynyl, C₃₋₃₀ cycloalkyl, C₃₋₃₀ cycloalkenyl, C₄₋₃₀ cycloalkynyl, C₇₋₃₀ aralkyl, C₇₋₃₀ alkaryl and C₅₋₃₀ aryl, preferably R³, R⁴ and R⁵ are independently selected from the group consisting of —H, C₁₋₁₅ alkyl, C₂₋₁₅ alkenyl, C₂₋₁₅ alkynyl, C₃₋₂₀ cycloalkyl, C₃₋₂₀ cycloalkenyl, C₄₋₂₀ cycloalkynyl, C₇₋₂₀ aralkyl, C₇₋₂₀ alkaryl and C₆₋₂₀ aryl, more preferably R³, R⁴ and R⁵ are independently selected from the group consisting of —H, straight chain C₁₋₁₀ alkyl, C₂₋₁₀ alkenyl and C₆₋₁₂ aryl, most preferably, R³, R⁴ and R⁵ are independently selected from the group consisting of H, methyl, ethyl, propyl, butyl, hexyl, cyclohexyl, octyl, nonyl, dodecyl, eicosyl, norbornyl, adamantyl, vinyl, propenyl, cyclohexenyl, benzyl, phenylethyl, phenylpropyl, phenyl, tolyl, dimethylphenyl, trimethylphenyl, ethylphenyl, propylphenyl, biphenyl, naphthyl, methylnaphthyl, anthryl, phenanthryl, benzylphenyl, pyrenyl, acenaphthyl, phenalenyl, aceanthrylenyl, tetrahydronaphthyl, indanyl, biphenyl, particularly methyl, ethyl, propyl and isopropyl.

20. The compound according to claim 19, wherein the polysaccharide, P, comprises 10-1×10⁵ monosaccharide moieties.

21. The compound according to claim 20, wherein V comprises a positively charged moiety comprising one or two positively charged nitrogen atoms, one or two positively charged phosphorous atoms, one or two positively charged sulfur atoms, or mixtures thereof.

22. The compound according to claim 21, wherein V comprises a singly charged quaternary ammonium, quaternary phosphonium or sulfonium group, having the formula ⁺—NR⁶₂—, ⁺—PR⁷₂—, or ⁺—SR⁸—, respectively, wherein R⁶, R⁷ and R⁸ are independently selected from the group consisting of H and monovalent hydrocarbon radicals.

23. A compound according to claim 22, wherein R⁶, R⁷ and R⁸ are independently selected from the group consisting of —H, C₁₋₂₀ alkyl, C₂₋₂₀ alkenyl, C₂₋₂₀ alkynyl, C₃₋₃₀ cycloalkyl, C₃₋₃₀ cycloalkenyl, C₄₋₃₀ cycloalkynyl, C₇₋₃₀ aralkyl, C₇₋₃₀ alkaryl and C₅₋₃₀ aryl, preferably R⁶, R⁷ and R⁸ are independently selected from the group consisting of —H, C₁₋₁₅ alkyl, C₂₋₁₅ alkenyl, C₂₋₁₅ alkynyl, C₃₋₂₀ cycloalkyl, C₃₋₂₀ cycloalkenyl, C₄₋₂₀ cycloalkynyl, C₇₋₂₀ aralkyl, C₇₋₂₀ alkaryl and C₆₋₂₀ aryl, more preferably R⁶, R⁷ and R⁸ are independently selected from the group consisting of —H, straight chain C₁₋₁₀ alkyl, C₂₋₁₀ alkenyl and C₆₋₁₂ aryl, most preferably, R⁶, R⁷ and R⁸ are independently selected from the group consisting of methyl, ethyl, propyl, butyl, hexyl, cyclohexyl, octyl, nonyl, dodecyl, eicosyl, norbornyl and adamantyl, vinyl, propenyl, cyclohexenyl, benzyl, phenylethyl, phenylpropyl, phenyl, tolyl, dimethylphenyl, trimethylphenyl, ethylphenyl, propylphenyl, biphenyl, naphthyl, methylnaphthyl, anthryl, phenanthryl, benzylphenyl, pyrenyl, acenaphthyl, phenalenyl, aceanthrylenyl, tetrahydronaphthyl, indanyl, biphenylyl, particularly methyl, ethyl, propyl and isopropyl.

24. The compound according to claim 22, wherein V comprises two positively charged nitrogen atoms, preferably —⁺NR⁶ ₂—R⁹—NR⁶₂⁺— or a group (A): 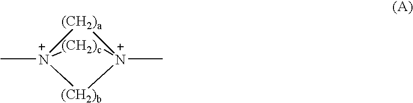
wherein a, b and c independently represent 1-10, preferably, 1-5, more preferably 1-3, most preferably 2, and wherein R⁹ is selected from the group consisting of C₁₋₂₀ alkanediyl, C₂₋₂₀ alkenediyl, C₂₋₂₀ alkynediyl, C₃₋₃₀ cycloalkanediyl, C₃₋₃₀ cycloalkenediyl, C₅₋₃₀ cycloalkynediyl, C₇₋₃₀ aralkylenediyl, C₇₋₃₀ alkarylenediyl and C₅₋₃₀ arylenediyl, preferably R⁹ is selected from the group consisting of C₁₋₁₆ alkanediyl, C₂₋₁₆ alkenediyl, C₂₋₁₆ alkynediyl, C₄₋₂₀ cycloalkanediyl, C₄₋₂₀ cycloalkenediyl, C₅₋₂₀ cycloalkynediyl, C₇₋₂₀ aralkylenediyl, C₇₋₂₀ alkarylenediyl and C₆₋₂₀ arylenediyl, more preferably R⁹ is selected from the group consisting of straight chain C₁₋₁₆ alkanediyl, C₂₋₁₆ alkenediyl, C₆₋₁₆ aralkylenediyl and C₆₋₁₆ alkarylenediyl, most preferably, R⁹ is selected from methylene, 1,2-ethylene, 1,2-propylene, 1,3-propylene, 1,2-butylene, 1,3-butylene, 1,4-butylene, 1,5-pentylene, 1,6-hexylene, 1,8-octylene, 1,10-decylene and 1,12-dodecylene.

25. The compound according to claim 24, wherein (A) is 1,4-diazoniabicyclo[2.2.2]octane.

26. The compound according to claim 22, wherein V comprises two positively charged sulfur atoms, preferably —⁺SR⁸—R¹⁰—SR⁸⁺ or a group (B) 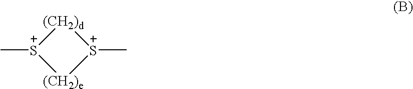
wherein d and e independently represent 1-10, preferably, 1-5, more preferably 1-3, most preferably 2, and wherein R¹⁰ is selected from the group consisting of C₁₋₂₀ alkanediyl, C₂₋₂₀ alkenediyl, C₂₋₂₀ alkynediyl, C₃₋₃₀ cycloalkanediyl, C₃₋₃₀ cycloalkenediyl, C₅₋₃₀ cycloalkynediyl, C₇₋₃₀ aralkylenediyl, C₇₋₃₀ alkarylenediyl and C₅₋₃₀ arylenediyl, preferably R¹⁰ is selected from the group consisting of C₁₋₁₆ alkanediyl, C₂₋₁₆ alkenediyl, C₂₋₁₆ alkynediyl, C₄₋₂₀ cycloalkanediyl, C₄₋₂₀ cycloalkenediyl, C₅₋₂₀ cycloalkynediyl, C₇₋₂₀ aralkylenediyl, C₇₋₂₀ alkarylenediyl and C₆₋₂₀arylenediyl, more preferably R¹⁰ is selected from the group consisting of straight chain C₁₋₁₆ alkanediyl, C₂₋₁₆ alkenediyl, C₆₋₁₆ aralkylenediyl and C₆₋₁₆ alkarylenediyl, most preferably, R¹⁰ is selected from methylene, 1,2-ethylene, 1,2-propylene, 1,3-propylene, 1,2-butylene, 1,3-butylene, 1,4-butylene, 1,5-pentylene, 1,6-hexylene, 1,8-octylene, 1,10-decylene and 1,12-dodecylene.

27. A compound according to claim 26, wherein (B) is 1,4-dithioniumcyclohexane.

28. The compound according to claim 22, wherein V comprises two positively charged phosphorus atoms, preferably —⁺PR⁷₂—R^{9′}—PR⁷₂⁺— or a group (C) 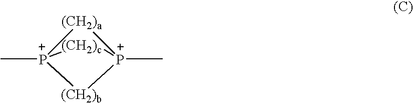
wherein a, b and c independently represent 1-10, preferably, 1-5, more preferably 1-3, most preferably 2, and wherein R^{9′} is selected from the group consisting of C₁₋₂₀ alkanediyl, C₂₋₂₀ alkenediyl, C₂₋₂₀ alkynediyl, C₃₋₃₀ cycloalkanediyl, C₃₋₃₀ cycloalkenediyl, C₅₋₃₀ cycloalkynediyl, C₇₋₃₀ aralkylenediyl, C₇₋₃₀ alkarylenediyl and C₅₋₃₀ arylenediyl, preferably R^{9′} is selected from the group consisting of C₁₋₁₆ alkanediyl, C₂₋₁₆ alkenediyl, C₂₋₁₆ alkynediyl, C₄₋₂₀ cycloalkanediyl, C₄₋₂₀ cycloalkenediyl, C₅₋₂₀ cycloalkynediyl, C₇₋₂₀ aralkylenediyl, C₇₋₂₀ alkarylenediyl and C₆₋₂₀ arylenediyl, more preferably R^{9′} is selected from the group consisting of straight chain C₁₋₁₆ alkanediyl, C₂₋₁₆ alkenediyl, C₆₋₁₆ aralkylenediyl and C₆₋₁₆ alkarylenediyl, most preferably, R^{9′} is selected from methylene, 1,2-ethylene, 1,2-propylene, 1,3-propylene, 1,2-butylene, 1,3-butylene, 1,4-butylene, 1,5-pentylene, 1,6-hexylene, 1,8-octylene, 1,10-decylene and 1,12-dodecylene.

29. A compound according to claim 28, wherein (C) is 1,4-diphosphoniabicyclo[2.2.2]octane.

30. A process for the preparation of a compound having formula (1), comprising reacting a compound having the formula (2):
P—{[COO⁻]f(Z^{g+})}ₙ (2)
wherein:
P is as defined in any preceding claim;
n is as defined in any preceding claim;
Z is a cation;
f represents 1/g; and
g represents 1, 2, 3, 4, 5 or 6;
with a group having the formula (3)
L-X (3)
wherein X is as defined in any preceding claim; and,
L is a leaving group.

31. A process according to claim 30 wherein L is selected from the group consisting of N-hydroxysuccinimide, N-hydroxybenzotriazole, nitrate, sulfate, bisulfate, phosphate (mono-, bi-, or triphosphate), carbonate, bicarbonate, acetate, tosylates, mesylates, brosylates, and halides including chloride, bromide, and iodide, preferably tosylate.

32. (canceled)

33. (canceled)

34. (canceled)

35. (canceled)

36. (canceled)

37. (canceled)

38. (canceled)

39. (canceled)
